(19) United States
(12) Patent Application Publication
(10) Pub. No.: US 2024/0109818 A1
(43) Pub. Date: Apr. 4, 2024

(54) UNDER-SINK WASTE COMPOSTER APPLIANCE

(71) Applicant: Midea Group Co., Ltd., Foshan (CN)

(72) Inventors: Paul R. Staun, Sharonville, OH (US); Vinayak Naik, Louisville, KY (US); Bryce Bornhorn, Hebron, KY (US); Joel Boyer, Louisville, KY (US); Maxwell E. Hanke, Louisville, KY (US)

(21) Appl. No.: 17/937,240

(22) Filed: Sep. 30, 2022

(51) Int. Cl. C05F 9/04; C05F 9/02; C05F 17/60; C05F 17/907; C05F 17/957; C05F 17/964; E03C 1/26

(52) U.S. Cl. CPC C05F 9/04; C05F 9/02; C05F 17/60; C05F 17/907; C05F 17/957; C05F 17/964; E03C 1/26

(57) ABSTRACT

A waste composter appliance may be positioned downstream of a garbage disposal and/or in an under-sink position. The appliance may include one or more augers. The appliance may include one or more housings containing the augers. The appliance may include one or more removable screens. The appliance may include a fan and/or heater.

### BACKGROUND

The present embodiments relate to a waste composter appliance, with particular embodiments shown for a waste composter appliance under or downstream of a residential/commercial sink.

Typical garbage disposals receive water and garbage (e.g. water/food/beverage waste) from a sink that is subsequently ground by a disposer/grinder, and the ground garbage/waste continues through the existing drainpipes to the waste water treatment plant and/or septic system. This may lead to problems including, but is not limited to, treatment of large amounts of ground garbage at the treatment plant and/or septic system, increased cost to clean water, and/or unused composting material. Thus, there is a need for a waste composter appliance downstream of the sink for purposes, such as increasing recycling, providing compost, reducing the cost of water treatment, reducing ground garbage downstream of the residential/commercial structure, etc. A need therefore exists in the art for an under-sink waste composter appliance.

### SUMMARY

The herein-described embodiments address these and other problems associated with the art by providing a sink/dishwasher using a waste composter. In some embodiments of the invention, for example, an under-sink waste composter appliance may include a first housing. In various embodiments, the application may include a first auger rotatably positioned in the first housing. In some embodiments, the appliance may include a first screen positionable from a first stowed position with the first housing to a first deployed position different from the first stowed position. In various embodiments, the appliance may include a second housing in downstream communication with the first housing. In some embodiments, the appliance may include a second auger rotatably positioned in the second housing. In various embodiments, the appliance may include a second screen positionable from a second stowed position with the second housing to a second deployed position different from the second stowed position.

In addition, in some embodiments, the appliance may include at least one heater, wherein the second housing may include at least one heater. In various embodiments, the appliance may include at least one fan, wherein at least one fan may circulate air from at least one of the first housing and/or the second housing. In some embodiments, the second housing may include an air inlet and an air outlet in communication with at least one fan. In various embodiments, the first auger may rotate slower than the second auger. In some embodiments, at least one of the first screen and/or the second screen may be positionable along a rotational axis of the first auger and/or the second auger between the first stowed position and the first deployed position and/or the second stowed position and the second deployed position, respectively. In various embodiments, the first screen may extend along a first length of the first auger and the second screen may extend along a second length of the second auger, wherein the first length is longer than the second length.

In some embodiments, an under-sink waste composter appliance may include at least one elongated auger. In various embodiments, the appliance may include at least one housing rotatably positioning at least one elongated auger. In some embodiments, the appliance may include at least one screen removably positionable relative to the housing, wherein at least one screen may be positionable from a stowed position with at least one housing to a deployed position different from the stowed position. In some embodiments, at least one screen may be cleaned in the deployed position.

In addition, in some embodiments, at least one screen may slide along a rotational axis of at least one auger between the stowed position and the deployed position. In various embodiments, at least one screen may include a handle. In some embodiments, at least one screen may include two screens. In various embodiments, the two screens may be removable independently from each other. In some embodiments, the appliance may include at least one fan, wherein at least one fan may circulate air from at least one housing. In various embodiments, the appliance may include at least one heater, wherein at least one housing may include at least one heater.

In some embodiments, a method of composting waste downstream of a garbage disposal may include providing one or more removable screens within one or more housings. In various embodiments, the method may include deploying the one or more removable screens from the one or more housings. In some embodiments, the method may include cleaning the one or more removable screens. In various embodiments, the method may include stowing the one or more removable screens to the one or more housings.

In addition, in some embodiments, the method may include conveying water and/or waste downstream of a garbage disposal using one or more augers within the one or more housings towards a collection bin. In various embodiments, the method may include sliding the one or more removable screens along a rotational axis of the one or more augers when both stowing and deploying the one or more removable screens. In some embodiments, the method may include venting the one or more housings using one or more fans. In various embodiments, the method may include heating the one or more housings using one or more heaters. In some embodiments, the one or more removable screens within the one or more housings may include a first removable screen in a first housing upstream from a second removable screen in a second housing.

These and other advantages and features, which characterize the invention, are set forth in the claims annexed hereto and forming a further part hereof. However, for a better understanding of the invention, and of the advantages and objectives attained through its use, reference should be made to the figures, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of an under-sink waste composter appliance consistent with some embodiments of the invention illustrating an embodiment of the one or more screens and/or collection bin in at least one stowed position.

FIG. 2 is a perspective view of the under-sink waste composter appliance in FIG. 1 illustrating the one or more screens and/or collection bin in at least one deployed position.

FIG. 3 is an exploded view of the embodiment under-sink waste composter appliance of FIG. 1.

FIG. 4 is a sectional view of the example under-sink waste composter appliance taken along line 4-4 of FIG. 1.

FIG. 5 is a block diagram of an example control system for the appliance.

### DETAILED DESCRIPTION

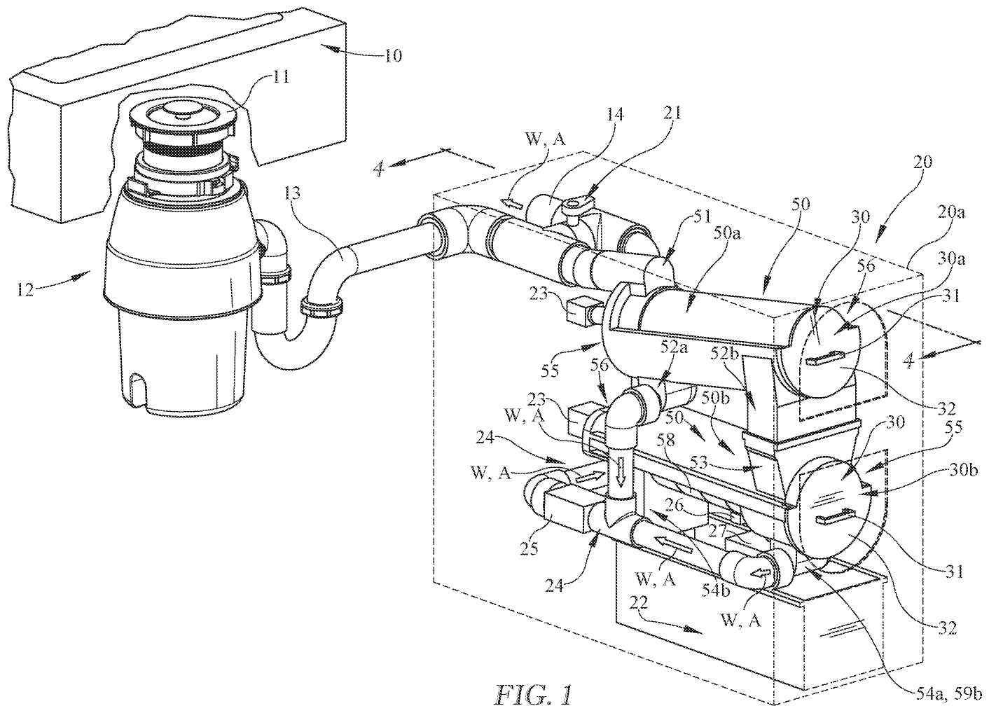

Turning now to the drawings, wherein like numbers denote like parts throughout the several views, FIG. 1 illustrates an example sink 10 in which the various technologies and techniques described herein may be implemented. Sink 10 is a residential-type countertop sink, and as such may include a front-mounted door that provides access to a garbage disposal 12 housed within the cabinet or housing. The door (not shown) is generally hinged and is pivotable between the open position and a closed position. When the door is in the open position, access is provided to the one or more sink drains 11, garbage disposal 12, existing drainpipes 14 from the sink/house, drain hose (not shown) from the dishwasher, if used, pipes 13 to the appliance 20 from the garbage disposal 12, and/or the under-sink waste composter appliance 20.

As shown in the Figures, the under-sink waste composter appliance 20 may be in fluid communication with the sink drain 11, dishwasher (not shown), and/or garbage disposal 12. The appliance 20 may be in fluid communication between the garbage disposal 12 and the existing drainpipe/vent system 14 of the residential/commercial structure. The appliance 20 may include a bypass mechanism 21 (e.g. open/close mechanism, direct flow, one or more valves) to bypass the appliance 20 and allow the fluid and/or ground waste from the garbage disposal 12 to go directly into the drainpipe 14 downstream of the appliance 20. For example, the bypass mechanism 21 may be used when the appliance 20 is being serviced, screens cleaned, bin emptied, etc. The bypass mechanism 21, if used, may be a manually operated valve as shown in the one embodiment and/or motorized (e.g. electromechanical valve). When the bypass mechanism 21 (e.g. closed) directs ground waste and/or fluid to be processed/composted towards the appliance 20, the fluid extracted or separated may be in fluid communication with or returned (e.g. pumped) to the drainpipe 14 (e.g. existing) downstream of the appliance 20. Further, air and/or gases within or from the appliance, or portions thereof, may be vented (e.g. forced air, fan, etc.) or in fluid communication with the drainpipe 14 (e.g. existing) downstream of the appliance 20. The fluid and/or air flow may pass through one or more pipes 24 together or separate from each other away from one or more portions of the appliance. One or more filters or screens 30 (e.g. first, second, etc.) may be removably positioned relative to the appliance 20, or portions thereof, to be cleaned or serviced by the user.

In some implementations, the appliance 20 and/or appliance housing 20a may include one or more material handling systems or conveying mechanisms to convey or push/pull the ground waste/water. In the one embodiment shown, the appliance 20, conveying mechanism, and/or appliance housing 20a may include one or more augers 40 connected to, within, or rotatably positioned in one or more housings 50. The auger(s) 40 may convey or push/pull the ground waste (e.g. food/water) received from the garbage disposal 12 towards the collection bin 22. In the one embodiment shown, the appliance 20 includes a first auger 40a rotatably positioned within a first housing 50a. Further, the appliance 20 may include a second auger 40b rotatably positioned within a second housing 50b. The second auger/housing 40b, 50b, if used, may be positioned downstream of or in downstream communication with the first auger/housing 40a, 50a. The one or more augers 40 may be rotated about one or more rotational axes R (e.g. first, second, third, etc.) by one or more motors or driving mechanisms 23. The one or more augers 40 may rotate at substantially the same and/or different speeds and/or one or more directions during operation. For example, the second auger 40b may rotate at a slower speed than the first auger 40a. One or more gears or pulleys may be used to change the speed between two or more augers 40 in some embodiments. For example, in embodiments that use a single motor or drive mechanism. The two or more augers 40 may rotate separately or together at one or more times or intervals during operation. Stopping rotation of the augers 40 may allow for drainage of water/fluid and/or heating without pushing waste or ground material forward. In the one embodiment shown, the first auger 40a rotates or conveys material in a first direction D1 and the second auger 40b rotates or conveys material in a second direction D2. The first and second directions may be the same or different. In the one embodiment shown, the first direction D1 is different than or in an opposite direction than the second direction D2. The augers 40 and/or housings 50 may be at one or more orientations (e.g. same, different) relative to each other or portions of the appliance. As shown in the one embodiment, the augers/housings 40, 50 are orientated in a vertical plane. The first housing/auger/screen 40a, 50a, 30a is positioned above or at a higher elevation than the second auger/housing/screen 40b, 50b, 30b. The housing 50 (e.g. first, second, etc.) may be substantially horizontal or angled. As shown in the one embodiment, the first housing/auger/screen 50a, 40a, 30a is angled upwardly (e.g. 10 degrees) in the direction (e.g. D1) of travel of the material/waste (e.g. waste inlet towards waste outlet). The second housing/auger/screen 50b, 40b, 30b is substantially horizontal in the direction (e.g. D2) of travel of waste. The housing/auger/screen 50, 40, 30 may be elongated (e.g. along the rotational axis R). The housing 50 may include one or more inlets and one or more outlets. As shown in the one embodiment, the first/second housing 50a, 50b may include an inlet and two outlets. The first housing 50a may include an inlet 51 (e.g. upper side of the housing), a first outlet 52a (e.g. lower side of the housing) at a lower/first end 55 of the housing, and/or a second outlet 52b (e.g. lower side of the housing) at an upper/second end 56 of the housing. The first auger 40a may extend from the inlet 51 and/or first outlet 52a to the second outlet 52b. The inlet 51 receives the waste and water from the garbage disposal 12. The first outlet 52a receives fluid from the first housing 50a, through a screen 30, and communicates with the drainage pipes/pumps 24, 25 of the appliance 20 to the existing drainage pipe 14 of the structure. The second outlet 52b receives waste/material compelled (e.g. pushed) by the auger 40a towards the second housing 50b (e.g. inlet) or collection bin 22. The second housing 50b, if used, may include an inlet 53 (e.g. upper side of the housing), a first outlet 54a (e.g. lower side of the housing) at a first/lower end 55 of the housing, and/or a second outlet 54b (e.g. lower side of the housing) at a second/upper end 56 of the housing. The second end 56 of the first housing/auger 50a, 40a may be adjacent the first end 55 of the second housing/auger 50b, 40b. The first end 55 of the first housing/auger 50a, 40a may be adjacent the second end 56 of the second housing/auger 50b, 40b. The second auger 40b, if used, may extend from the inlet 53 and/or first outlet 54a to the second outlet 54b. The inlet 53 receives the waste (e.g. ground) and water (e.g. remaining) from the garbage disposal 12 and/or first housing 50a, or portions thereof. The first outlet 54a receives fluid (e.g. remaining fluid, if any), through the screen 30, from the first/second housing and communicates with the drainage pipes/pumps 24, 25 of the appliance 20 to the drainpipe 14 (e.g. existing) of the structure. The second outlet 54b receives waste/material compelled (e.g. pushed) by the auger 40b towards the collection bin 22 (e.g. removable). It should be understood that the housings, augers, screens, inlets (e.g. air, water), and/or outlets (e.g. air, water), or portions thereof, may be of a variety of quantities, shapes, sizes, constructions, and positions relative to each other and still be within the scope of the invention.

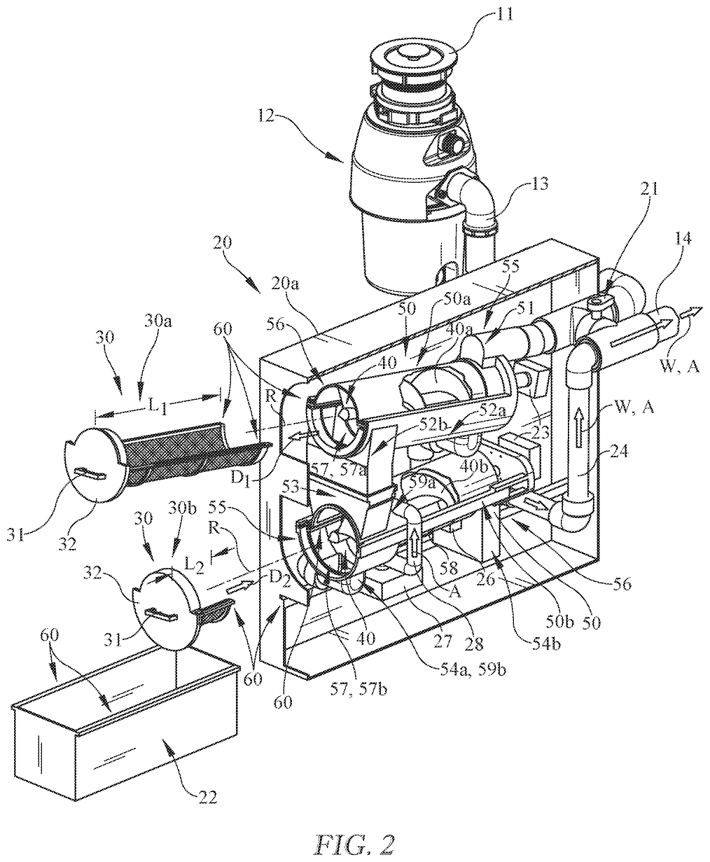

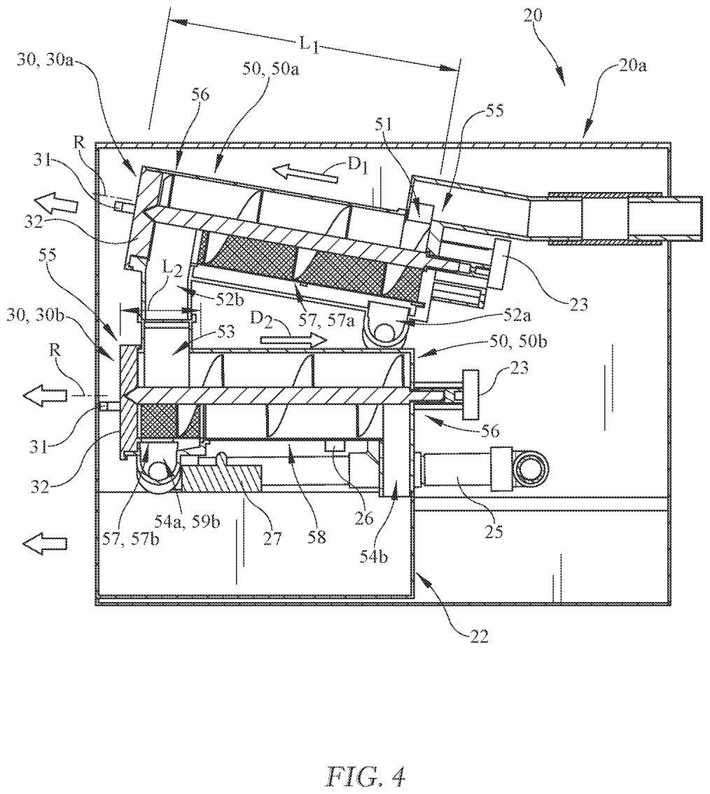

In some implementations, the appliance 20, housing 50, and/or auger 40 may include one or more screens or filters 30. The one or more screens 30 may be removable/deployed from the appliance 20, or portions thereof, to be cleaned or remove the buildup of material or waste (e.g. ground). The one or more housings 50 may include one or more screens 30 removably positionable relative to the housing 50, auger 40, and/or appliance 20. In some embodiments, one or more housings 50 may not include a screen. The one or more screens 30 may be positionable from at least one stowed position (see FIGS. 1 and 4) with the one or more housings 50 and at least one deployed position (see FIG. 2) different from at least one stowed position. For example, one deployed position may fully remove the screen 30 from the housing or compartment as shown in FIG. 4. Another deployed position, for example, may extend the screen 30 partially away from the stowed position while remaining in contact with the housing 50. The one or more screens 30 may be cleaned of material/waste buildup by the user when in the one or more deployed positions. The one or more screens 30 may be slidably received within one or more compartments 57 of the one or more housings 50. The one or more screens 30 may slide into and out of engagement with the housing 50 (e.g. compartment) along the direction of the auger 40 or rotational axis R. The appliance 20, housing 50, bin 22, and/or screen 30 may include one or more slide mechanisms 60 (e.g. rails, slides, tracks, rollers) allowing the sliding between the housing 50 and screen 30. In the one embodiment shown, the slide mechanism 60 may be one or more rails positioned on the housing and/or screen, or portions thereof. Another slide mechanism(s) 60 may be positioned between the bin 22 and the housing 20a. The one or more screens 30 may allow water within the appliance, or portions thereof, to drain away from the housings 50 and/or food material/waste/compost.

As shown in the one embodiment, the appliance 20 and/or housing(s) 50 may include a first screen 30a and a second screen 30b. The first screen 30a may be positionable from at least one first stowed position with the first housing 50a (see FIGS. 1 and 4) and at least one first deployed position (see FIG. 2) different from at least one first stowed position. The second screen 30b may be positionable from at least one second stowed position with the second housing 50b (see FIGS. 1 and 4) and at least one second deployed position (see FIG. 2) different from at least one second stowed position. The first housing 50a may include at least one first compartment 57a to stow at least a portion of the removable first screen 30a therein in the stowed position. The second housing 50b may include at least one second compartment 57b to stow at least a portion of the removable second screen 30b therein in the stowed position. The compartment 57 may have define or include an end opening to receive the screen, or portions thereof. The first screen 30a may project from the second end 56 of the first housing 50a and/or first compartment 57a in the deployed position. The second screen 30b may project from the first end 55 of the second housing 50b and/or second compartment 57b in the deployed position. In at least one deployed position, the screen(s) 30 may be replaced, cleaned, and/or inspected. The one or more removable screens 30 (e.g. first screen 30a, second screen 30b) may be removable independently from each other as shown in the one embodiment. Alternatively, two or more screens 30 may be positionable together between the stowed position and the deployed position. The one or more removable screens 30 may include a handle 31 (e.g. positioned at one end of the screen/housing/auger) accessible by the user in the front, cabinet, through the door, and/or under the sink. The one or more removable screens 30 may include an end cap 32 closing off the respective end of the housing/compartment. A frame inwardly projecting from the end cap may include the mesh or openings therein. The end cap 32 may include the handle.

In some implementations, the one or more screens 30 may be in a variety of positions relative to the one or more housings 50 and/or augers 40. The screens 30 may allow fluid or water (e.g. excess) to drain (e.g. gravity) towards the respective outlet (e.g. first outlet of the first housing and/or second housing, second outlet of the first housing) and/or separate from the ground waste. The screens 30 may be positioned upstream from or at a higher elevation than the one or more outlets of the housings 50 and/or compartments 57. The first screen 30a and/or first compartment 57a may extend a first length L1 of the first housing 50a from the first end 55 towards the second end 56 and/or the first auger 40a. The water may drain through the first screen 30a, enter at least a portion of the first compartment/channel 57a (e.g. defined by the first screen and inner periphery of the first housing), and continue through the first outlet 52a and/or second outlet 52b towards the pump 25 and/or drainpipe 14. The second screen 30b and/or second compartment 57b may extend a second length L2 of the second housing 50b from the first end 55 towards the second end 56 and/or the second auger 40b. The water may drain through the second screen 30b, enter at least a portion of the second compartment/channel 57b (e.g. defined by the second screen and inner periphery of the second housing), and continue through the first outlet 54a towards the pump 25 and/or drainpipe 14. The first and/or second screen 30a, 30b may be elongated and arcuate in shape and surround at least a portion of the length/height of the auger 40 (e.g. first, second). The one or more augers 40 (e.g. first and/or second) may scrape against the one or more screens 30 (e.g. adjacent surface) to help clean the screen/openings defined by the screen 30 and/or push water through the screen. In various embodiments, the distal free ends or leading edges of the auger may include a wiping blade (e.g. silicone) to scrap the one or more surfaces/openings of the screen. In some embodiments, the one or more augers 40 may be reversible in direction/rotation/speed. A reversal or change in direction may clean a portion of the one or more screens or assist in drying.

The compartment(s) 57 and/or screen(s) 30 may extend for a variety of lengths of the elongated auger/housing 40, 50. As shown in the one embodiment in FIG. 4, the first screen/compartment extends for the first length L1 along the first auger 40a and/or the second screen/compartment extends for the second length L2 along the second auger. The first length L1 may be longer than the second length L2 as shown in the one embodiment. In some embodiments, the one or more screens 30, or portions thereof, may define a plurality of openings having a variety of shapes, sizes, quantities, and constructions. The screens 30 may be a wire mesh defining the openings in some embodiments. Although the openings may be the same size and shape in some embodiments, smaller openings may be positioned adjacent the bottom (e.g. curved) of the screen/housing and larger openings may be positioned on lateral sides away (e.g. curved) from the smaller openings. The openings defined by the screen may be different or the same between the first screen and the second screen. For example, the first screen may define openings larger than the openings defined by the second screen in some embodiments.

In some implementations, the appliance 20, housing 50 (e.g. first, second), and/or auger 40 (e.g. first, second), or portions thereof, may include one or more heaters 26. The one or more heaters 26 may dry and/or remove the moisture from the air and/or ground waste within the appliance, or portions thereof. In the one embodiment shown, the housing 50 (e.g. second), or portions thereof, may include the one or more heaters 26. The bottom periphery/wall/half/side 58 (e.g. metal wall) of the second housing 50b may include one or more heaters 26 (e.g. wire). The wire heater may heat the surface (e.g. inner periphery/wall) of the second housing 50b (e.g. one or more walls, 58) to dry the ground waste and/or remove moisture from the air within at least the second housing 50b. The wall/periphery 58 with the heater(s) 26 (e.g. wire) may be adjacent the second end 56 of the second housing 50b and the second screen(s) 30b may be adjacent the first end 55 of the second housing 50b. The wall(s) 58 with heater(s) 26 and the second screen 30b may be adjacent the bottom of the second housing 50b and/or second auger 40b. In some embodiments, the first housing 50a may include one or more heaters alone or in combination with the heaters within the second housing. It should be understood that the heater(s) or heating device may be of a variety of shapes, sizes, constructions, positions, and quantities and still be within the scope of the invention.

In some implementations, the appliance 20, housing 50 (e.g. first, second), and/or auger 40 (e.g. first, second), or portions thereof, may include one or more fans, air supply, or circulating mechanisms 27. The one or more fans 27 may be in fluid communication with one or more portions of the appliance 20. The fan 27 may circulate air from one or more housings 50 (e.g. first and/or second). The fan 27 may push/pull air (e.g. moist/heated air) from inside one or more housings (e.g. first, second) out of or downstream through the drainpipe 14 of the structure (e.g. residential, commercial). This air circulation may remove odor and/or reduce the need to filter the exhaust air. In some embodiments, one or more filters may used within or in communication with the air flow. For example, a carbon filter may be used to condition the air. In some embodiments, a one-way check valve may be used on the exhaust air or air flow pipes into the house drain pipes. The appliance drain pipes and exhaust air pipes may be separate or may overlap in one or more portions as shown in the one embodiment. In the one embodiment shown, the fan or blower 27 may be in fluid communication with at least the second housing 50b. The second housing 50b may include or define one or more air inlets 59a and one or more air outlets 59b in communication with one or more fans 27. The air inlet 59a may be in downstream communication with the fan 27 via one or more first air pipes 28. Although the air outlet 59b may be shown in one embodiment as the first outlet 54a of the second housing 50b, the air outlet 59b may be different from first outlet 54a or in a different position in some embodiments. The one or more pumps 25 may be downstream from the air outlet 59b and/or the first outlet 54a of the second housing 50b via one or more pipes 24 in communication with the existing drainpipes 14.

In use in one implementation, the food and/or waste is placed down the sink drain 11 and enters the garbage disposal 12 where it is ground up. The watery/ground waste or sludge is sent from the disposal through the P-trap and then into the appliance 20. The waste sludge enters the appliance 20 when the bypass mechanism 21 is closed. This bypass mechanism 21 (e.g. valve) may be motorized/manually operated and if opened may divert all the waste sludge to the downstream drainpipe 14 thereby bypassing the appliance 20. This may allow the consumer's sink 10 to remain usable even if the food recycler or appliance 20 is not desired to be used. Water/food may be conveyed downstream of the garbage disposal via the one or more augers 40 within the one or more housings 50 towards the collection bin 22. The waste sludge passes through the first housing 50a via the first auger 40a and into the second housing 50b. The remaining waste sludge passes through the second housing 50b via the second auger 40b into the collection bin 22. Water from the waste sludge may pass through one or more screens 30 of the one or more housings 50 towards the pump 25. When operated, the pump 25 may discharge the collected water to the downstream drainpipes 14. In some embodiments, the first auger 40a may be at a 10° incline and may aid in drainage. The first housing/auger 50a, 40a may include the removeable first wire mesh screen 30a that covers most of the length L1 of the first auger 40a. The transfer chute/outlet 52b between the first housing/auger 50a, 40a and the second housing/auger 50b, 40b may be a funnel that is wide enough that waste material does not become clogged or reduces clogging. The second housing/auger 50b, 40b may be positioned horizontally. Alternatively, the second housing may be inclined as well in some embodiments. The second housing/auger 50b, 40b may include the removable second wire mesh screen 30b. In some embodiments, the second screen length L2 may be shorter than the first length L1 of the first screen 30a. The appliance 20, or portions thereof, and/or housing(s) 50 may be heated using one or more heaters 26. After the second screen 30b ends along the direction of the second auger 40b, the second auger 40b may have a sheet metal bottom/wall 58 with one or more heaters 26, if used, attached. The second auger 40b may move/rotate approximately 10 times slower than the first auger 40a to sufficiently heat the food waste or sludge therein. The now dewatered, and heated food sludge may then drop by gravity into the collection bin 22 and may be used as a compost material. The bin 22 can slide out from a stowed position to a deployed position for the user to empty its contents. The water W that is drained/screened out of each auger may be sent into the pump 25 to return it to the height of the drainpipe 14. The appliance 20, or portions thereof, and/or housing(s) 50 may be vented using one or more fans 27. On the far side of the auger 40 (e.g. second) may be the fan 27 for handling excess moisture and/or odors. The fan 27, if used, is positioned to pull/push air A from the bin/appliance and pushes it though the second auger/housing 40b, 50b, through the pump 25, and/or downstream pipe 24 to the height of the drainpipe 14. The one or more screens may be deployed from the one or more housings. The user may clean or empty collected materials on the removable screens when in the deployed position. Once cleaned, the user may return or stow the removable screens 30 to the one or more housings. The removable screens may slide along the rotational axis R of the one or more augers, respectively, when stowing and/or deploying the removable screen(s).

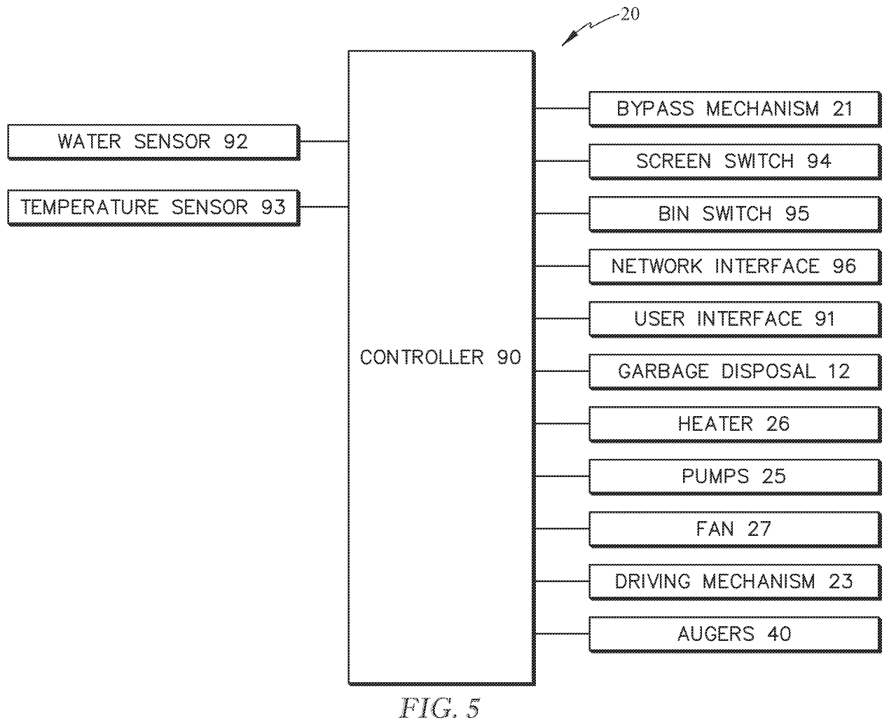

In some implementations as shown in FIG. 5, the appliance 20, or portions thereof, may be under the control of a controller 90 that receives inputs from a number of components and drives a number of components in response thereto. Controller may for example, include one or more processors and a memory (not shown) within which may be stored program code for execution by the one or more processors. The memory may be embedded in controller, but may also be considered to include volatile and/or non-volatile memories, cache memories, flash memories, programmable read-only memories, read-only memories, etc., as well as memory storage physically located elsewhere from controller, e.g., in a mass storage device or on a remote computer interfaced with controller.

The controller 90 may be interfaced with various components of the appliance 20, including the garbage disposal 12, dishwasher (not shown), and/or bypass mechanism 21 (e.g. valve) that is coupled to a water/ground waste source or disposal to introduce into the appliance. Controller may also be coupled to the one or more heaters 26, the one or more pumps 25 that recirculates air/water downstream to the drainpipes 14, the fan or air supply 27 that may provide air for use in drying the air and/or waste, the driving mechanism(s) 23 and/or augers conveying ground waste/water during a composting cycle.

Additional sensors and actuators may also be used in some embodiments, including one or more water/moisture sensors 92 to determine the level of water or moisture present in one or more locations/waste in the appliance 20, one or more temperature sensors 93 to determine the temperature of one or more areas heated by the heater(s) 26, one or more screen switches 94 to determine when one or more screens 30 are stowed/deployed, and/or a bin switch 95 to determine when the bin is present (e.g. stowed/deployed) to receive material. The one or more screen switches 94 and/or bin switch(s) 95 may prevent the appliance, or portions thereof, from operating or moving material/fluid when not present. If used, the switch or other suitable sensors (e.g. contact sensor) may be used to detect or verify the presence of the one or more screens. As a non-limiting example, the water sensor or other suitable sensors (e.g. cameras), if used, may be desirable to detect screen clogging or trigger the bypass valve to bypass the appliance if a problem occurs. Moreover, controller 90 may be coupled to a user interface 91 including various input/output devices such as knobs, dials, sliders, switches, buttons, lights, textual and/or graphics displays, touch screen displays, speakers, image capture devices, microphones, etc. for receiving input from and communicating with a user. In some embodiments, controller 90 may also be coupled to one or more network interfaces 96, e.g., for interfacing with external devices via wired and/or wireless networks such as Ethernet, Bluetooth, NFC, cellular and other suitable networks. In some embodiments, a user may be alerted by the one or more sensors (e.g. water sensor) by a user interface that a fault (e.g. clogged path or structure, excess water, appliance offline) has occurred, on/off and/or operational status of the appliance, and/or that a user may need to remove and/or clean the one or more screens.

In some implementations, the one or more switches (e.g. 94, 95) may be a contact sensor, or micro switch. In some embodiments such a contact sensor may be disposed on or in appliance 20 and/or housings 50, or variety of positions within the appliance. In some embodiments, the one or more micro switches, if used, may be actuated through minimal physical force/contact by the one or more bins/screens by use of a tipping-point mechanism, and as such they may, in some instances, be desirable for the detection of a location and/or presence of a bin/screen. In such embodiments, the screen/bin signals or data may be in the form captured by the contact sensor. One or more parameters of the composting cycle may be configured based on the one or more switch sensors, or contact sensor. As a non-limiting example, the contact sensor, if used, may be desirable to detect the presence of the screen(s) (e.g. 30a, 30b) and/or bin 22.

Moreover, in some embodiments, at least a portion of controller 90 may be implemented externally from the appliance 20, e.g., within a mobile device, a cloud computing environment, etc., such that at least a portion of the functionality described herein is implemented within the portion of the controller that is externally implemented. In some embodiments, controller may operate under the control of an operating system and may execute or otherwise rely upon various computer software applications, components, programs, objects, modules, data structures, etc. In addition, controller may also incorporate hardware logic to implement some or all of the functionality disclosed herein. Further, in some embodiments, the sequences of operations performed by controller to implement the embodiments disclosed herein may be implemented using program code including one or more instructions that are resident at various times in various memory and storage devices, and that, when read and executed by one or more hardware-based processors, perform the operations embodying desired functionality. Moreover, in some embodiments, such program code may be distributed as a program product in a variety of forms, and that the invention applies equally regardless of the particular type of computer readable media used to actually carry out the distribution, including, for example, non-transitory computer readable storage media. In addition, it will be appreciated that the various operations described herein may be combined, split, reordered, reversed, varied, omitted, parallelized and/or supplemented with other techniques known in the art, and therefore, the invention is not limited to the particular sequences of operations described herein.

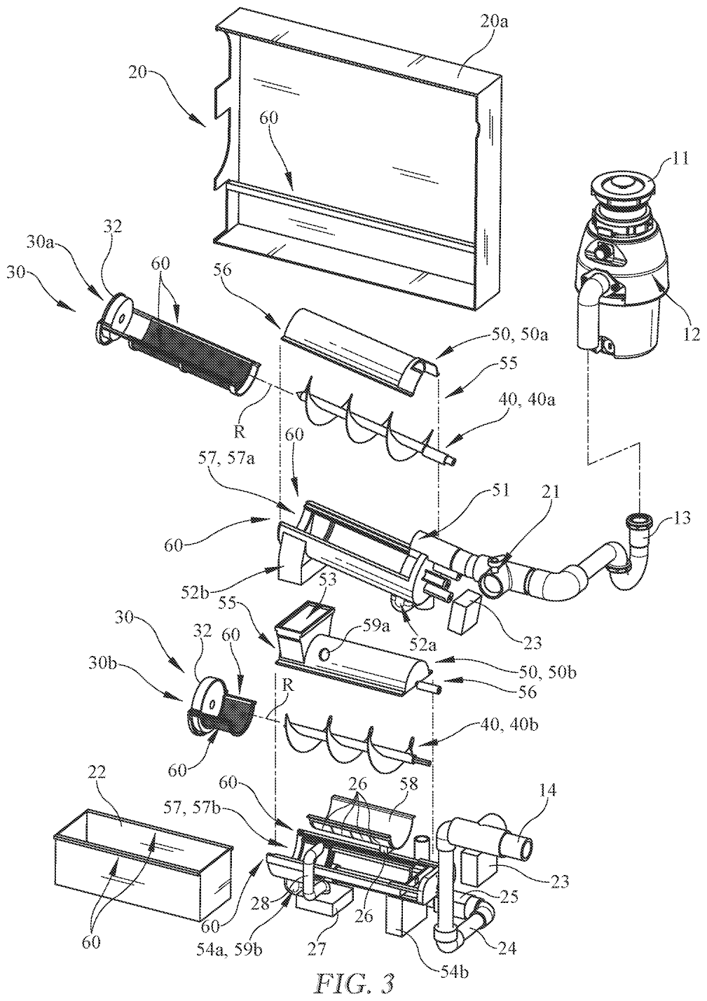

Numerous variations and modifications to the appliance 20 illustrated in FIGS. 1-5 will be apparent to one of ordinary skill in the art, as apparent from the description above. Therefore, the invention is not limited to the specific implementations discussed herein.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. An under-sink waste composter appliance comprising:
a first housing;
a first auger rotatably positioned in the first housing;
a first screen positionable from a first stowed position with the first housing to a first deployed position different from the first stowed position;
a second housing in downstream communication with the first housing;
a second auger rotatably positioned in the second housing; and
a second screen positionable from a second stowed position with the second housing to a second deployed position different from the second stowed position.

2. The under-sink waste composter appliance of claim 1 further comprising at least one heater, wherein the second housing includes the at least one heater.

3. The under-sink waste composter appliance of claim 1 further comprising at least one fan, wherein the at least one fan circulates air from at least one of the first housing and/or the second housing.

4. The under-sink waste composter appliance of claim 3 wherein the second housing includes an air inlet and an air outlet in communication with the at least one fan.

5. The under-sink waste composter appliance of claim 1 wherein the first auger rotates slower than the second auger.

6. The under-sink waste composter appliance of claim 1 wherein at least one of the first screen and/or the second screen is positionable along a rotational axis of the first auger and/or the second auger between the first stowed position and the first deployed position and/or the second stowed position and the second deployed position, respectively.

7. The under-sink waste composter appliance of claim 1 wherein the first screen extends along a first length of the first auger and the second screen extends along a second length of the second auger, wherein the first length is longer than the second length.

8. An under-sink waste composter appliance comprising:
at least one elongated auger;
at least one housing rotatably positioning the at least one elongated auger; and
at least one screen removably positionable relative to the housing, wherein the at least one screen positionable from a stowed position with the at least one housing to a deployed position different from the stowed position, and wherein the at least one screen can be cleaned in the deployed position.

9. The under-sink waste composter appliance of claim 8 wherein the at least one screen slides along a rotational axis of the at least one auger between the stowed position and the deployed position.

10. The under-sink waste composter appliance of claim 8 wherein the at least one screen includes a handle.

11. The under-sink waste composter appliance of claim 8 wherein the at least one screen includes two screens.

12. The under-sink waste composter appliance of claim 11 wherein the two screens are removable independently from each other.

13. The under-sink waste composter appliance of claim 8 further comprising at least one fan, wherein the at least one fan circulates air from the at least one housing.

14. The under-sink waste composter appliance of claim 8 further comprising at least one heater, wherein the at least one housing includes the at least one heater.

15. A method of composting waste downstream of a garbage disposal comprising the steps of:
providing one or more removable screens within one or more housings;
deploying the one or more removable screens from the one or more housings;
cleaning the one or more removable screens; and
stowing the one or more removable screens to the one or more housings.

16. The method of claim 15 further including conveying water and/or waste downstream of a garbage disposal using one or more augers within the one or more housings towards a collection bin.

17. The method of claim 16 further including sliding the one or more removable screens along a rotational axis of the one or more augers when both stowing and deploying the one or more removable screens.

18. The method of claim 15 further including venting the one or more housings using one or more fans.

19. The method of claim 15 further including heating the one or more housings using one or more heaters.

20. The method of claim 15 wherein the one or more removable screens within the one or more housings includes a first removable screen in a first housing upstream from a second removable screen in a second housing.
